(19) United States
(12) Patent Application Publication
(10) Pub. No.: US 2016/0048932 A1
(43) Pub. Date: Feb. 18, 2016

(54) METHOD FOR PARTITIONING SOCIAL MEDIA ENVIRONMENTS AND INTEGRATING COLLABORATION APPLICATIONS

(71) Applicants: Steve H. McNelley, San Juan Capistrano, CA (US); Jeffrey Machtig, Lake Forest, CA (US)

(72) Inventors: Steve H. McNelley, San Juan Capistrano, CA (US); Jeffrey Machtig, Lake Forest, CA (US)

(21) Appl. No.: 14/458,154

(22) Filed: Aug. 12, 2014

(51) Int. Cl. G06Q 50/00; G06Q 30/02; G06Q 50/12; G06Q 10/10; G06Q 30/00; H04L 29/08; G06Q 10/02

(52) U.S. Cl. CPC G06Q 50/01; H04L 67/10; H04L 67/22; G06Q 30/0269; G06Q 10/02; G06Q 10/1095; G06Q 30/016; G06Q 50/12

(57) ABSTRACT

Disclosed herein is a social media platform that enables a user with one account to access multiple social environments partitioned for various aspects of their lives. The partitioned platform creates environments for a user's personal life and professional life and also connected and partitioned to the user's enterprise life, which is privately controlled by an organization such as a business. Methods for shared computing devices are disclosed for use with the social media platform in physical locations such as corporate meeting rooms and hotel rooms. Further a method in presented for suggesting, navigating, selecting and engaging one of numerous disconnected collaboration applications. Further several methods for increasing social media adoption are disclosed as well as integration of the platform with a property management system.

### CROSS-REFERENCE TO PRIOR APPLICATIONS

Not Applicable

### U.S. GOVERNMENT SUPPORT

Not Applicable

### TECHNICAL FIELD

### Area of the Art

The present disclosure relates generally to social media, collaboration applications and shared computing devices all of which use data networks such as the internet and private enterprise networks.

### SUMMARY OF THE INVENTION

Social networking has now become a vital communication medium for over a billion people. Its widespread adoption, in just a short time, is staggering; yet its impact on people in measures of improved human relations, psychological wellbeing and consumption of time are growing areas of concern. Most disturbing is how peoples' lives have been compartmentalized into numerous social networking sites for groups, interests, business, personal life and professional life. People are forced to constantly log in, navigate, interact and manage these different sites. Still further “how” people meet has become just as important as “who” will meet, “when” they will meet and “where” will the meet. There are now hundreds of collaboration applications that enable people in one way or another to conduct a meeting online. Managing “how” to meet is increasingly frustrating since there are so many applications to do so. What is needed to resolve these problems is the central focus of the present invention.

The present invention provides in a single social media platform with partitioned environments for major aspects of a person's life. This includes a person's personal life, professional life and organizational work life. Any and all well-known social networking features and functionalities are subject to the partitioning program logic presented herein. The person is able to utilize under a single user account multiple social media environments intelligently partitioned for each aspect of a person's life.

Another primary embodiment of the present invention is to enable people to initiate a meeting, respond to a meeting request and easily determine how each other meets online with collaboration applications they may share in common. Also, the participants are presented, if applicable, alternative methods of how to meet and enable them to mutually engage a particular new collaboration application among of grouping of application options.

Still further, the present invention considers how the management and presentation of multiple collaboration applications can be applied to shared computing devices, and further their integration with the partitioned social media platform in any enterprise setting. Specifically many unique embodiments of the present invention benefit hotel guests so that they may have an enhanced hotel stay experience. Also, unique search methods, integration of third party websites into the platform, and navigating a virtual world to simplify the organization of complex data are disclosed.

All the above are computer hardware based with specific functionalities achievable with software programming logic. Only computers, in their many forms, enable the complexity of directing numerous points of data in the partitioned social media platform to achieve the described outcomes. Certainly, any and all advancements in computer hardware and software are all applicable to the embodiments disclosed herein.

### DESCRIPTION OF THE FIGURES

The included drawings are for illustrative purposes and serve only to provide examples of possible structures and process steps for the disclosed inventive systems and methods. These drawings in no way limit any changes in form and detail that may be made to embodiments by one skilled in the art without departing from the spirit and scope of the disclosure.

FIG. 1 illustrates a prior art diagram of a disjointed user experience having numerous social media accounts for various aspects of a user's life.

FIG. 2 illustrates a prior art diagram of a disjointed user experience having numerous disconnected collaboration application accounts and complexity in user management.

FIG. 3 illustrates the present invention partitioning a social media platform into personal and professional life environments.

FIG. 4 illustrates the present invention further partitioning an enterprise life environment.

FIG. 5 illustrates the present invention partitioning features among environments.

FIG. 6 illustrates the present invention creating identities in a social media platform.

FIG. 7 illustrates the present invention creating worlds within a social media platform and environments.

FIG. 8 illustrates the present invention partitioning components of a social media platform.

FIG. 9 illustrates the present invention grouping collaboration applications.

FIG. 10 illustrates the present invention integrating meeting engagement.

FIG. 11 illustrates the present invention enabling a meeting set-up procedure.

FIG. 12 illustrates the present invention integrating advertising logic for collaboration applications.

FIG. 13 illustrates the present invention displaying various modes of a social media platform design and displayed across various devices.

FIG. 14 illustrates the present invention displaying a visual layout of an engagement zone and horizontal sliding content zones.

FIG. 15 illustrates the present invention displaying a visual layout of an engagement zone and vertical sliding content zones.

FIG. 16 illustrates the present invention integrating a social media platform with a property management system.

FIG. 17 illustrates the present invention integrating a social media platform with a property management system and recognizing hotel guest status.

FIG. 18 illustrates the present invention displaying integrated in-room services.

FIG. 19 illustrates the present invention integrating a multi-functional shared computing device.

FIG. 20 illustrates the present invention creating a hotel guest social media account.

FIG. 21 illustrates the present invention searching a social media platform and internet resources and presenting a unified navigational experience.

FIG. 22 illustrates the present invention displaying searching a social media platform and internet resources as a unified navigational experience.

FIG. 23 illustrates the present invention displaying a visual layout and symbolic representation of a virtual environment.

FIG. 24 illustrates the present invention displaying a dashboard for consolidated view of environment activity.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a unified solution to employing multiple social media platforms.

While social media are now a part of one's everyday life, things have become oversaturated and confusing to manage. Further, current social media are fundamentally disconnected from the psychology of human activity. People are more complex than a single identity for the person. Certainly many well-known social media platforms relate to a person's business life. Likewise another social media site may cater to a user's personal life. This division of areas of a person's life is quite natural and people easily shift from focus when relating to other people in differing contexts. The issue is now that social media have become intrusive and complicated to manage. Users must shift between social platforms to communicate, and that slows down and makes cumbersome communication. Further, visual layout and navigational controls are different among various social platforms and that is another issue frustrating users.

Additionally, people are now overwhelmed by collaboration applications that enable voice calls, video calls, chat and other types of one way and two way communication. Many of these applications do not interoperate leaving people not knowing how to engage one another.

Added to this complexity are enterprise based social media applications. These applications are usually in locked down private networks and all of which is yet another frustrating application the user must learn and manage. A private enterprise network may certainly be a business network, but also can be a hotel network connecting guests and offering other hotel features, etc. Meetings rooms in businesses, schools, and hotels rooms often have shared personal computing devices and these devices are often hindered by restricted access or incapable of processing social media and collaboration applications.

Disclosed herein are methods and related systems resolving the above mentioned complexities and provide users a unified solution that enables easy shifting from the various parts of their lives in one social media platform and quickly assess and engage collaboration applications with others. Further disclosed are personal computing devices connected through public and private data networks with shared computing devices in numerous locations including business meeting rooms and hotel rooms.

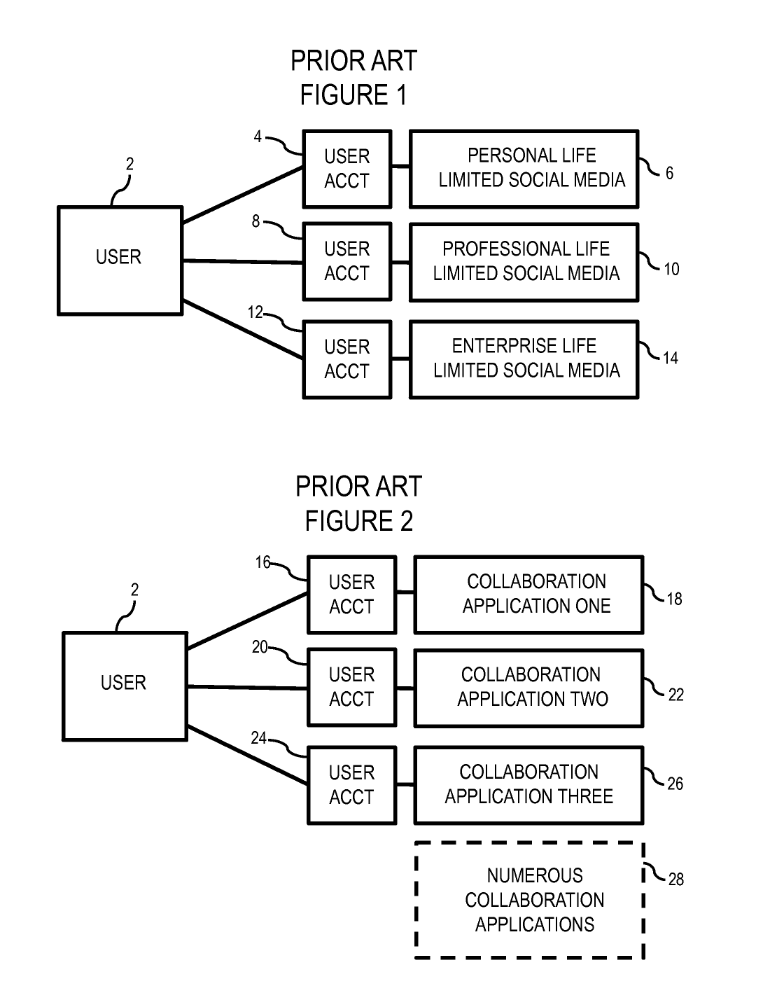

FIG. 1 is a prior art illustration of how current social media is disconnected and forces a user 2 to have a first user account 4 associated with a personal life limited social media 6, a second user account 8 associated with a professional life limited social media 10, and a third user account 12 associated with a enterprise life limited social media 14 which often is private and secure to an organization. The user 2 must manage the complexity of having multiple social media accounts that are fundamentally disconnected. Though the user 2 has multiple life identities current social media applications do not offer the user 2 an effective way to manage all of them in one application, share similar navigational experience and cross reference and utilize data from each of these limited social media applications servicing the user's 2 personal life, professional life and enterprise life.

FIG. 2 is a prior art illustration of how current collaboration applications are disconnected and forces the user 2 to have a first app user account 16 associated with a collaboration application one 18, a second app user account 20 associated with a collaboration application two 22, and a third app users account 24 associated with a collaboration application three 26. Still further the user 2 can be connected to a numerous collaboration applications 28. The user must manage multiple collaboration applications for engaging a video call, audio call, chat, text, notifications, data sharing, content sharing such as an interactive whiteboard and one way recordings such as voice and video messaging. The user 2 has no way to present effectively to others or receive from others which collaboration application each has nor a means of effectively communicating which one to utilize and when.

The present invention specifically presents numerous aspects for an improved social media platform. Methods are presented herein to assist one of ordinary skill in the art to initiate the creating of the invention in all of its novel variants. Modifications to the present invention would not depart from the scope and intent of the invention and its many novel variations. While the methods are presented in both text and figures these methods also present complex systems. Program logic, and numerous software program modules all of which are intended to be fully integrated in a single interconnected software program. Still further the method and related complex systems are further intended to be integrated with unique apparatuses presented herein that work in conjunction with the described methods and complex systems. It is to be expressly understood that many of the present invention embodiments rely on computer hardware to process software programs and that hardware may include any hardware components necessary to achieve the software programs functional purpose. All future advances in computer hardware and program software are applicable to the present invention.

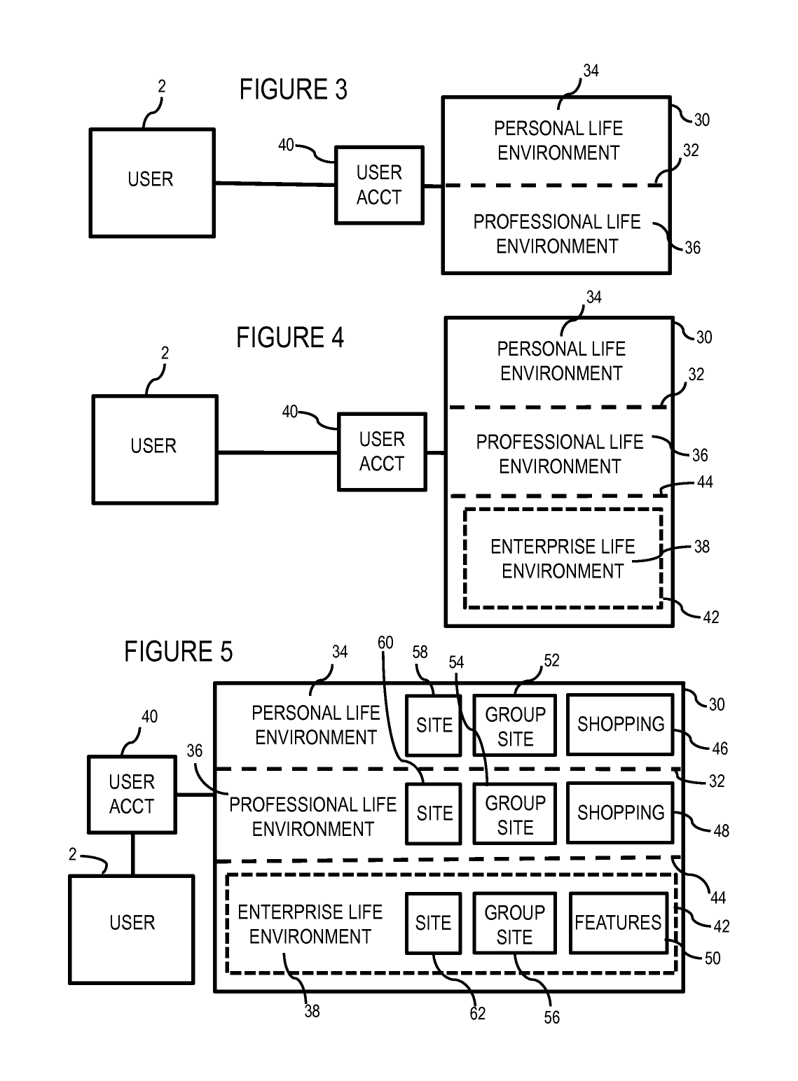

FIG. 3 of the present invention illustrates a method and related system of functionality of a social media platform 30 that divides a person's social media experience into two distinct environments of a personal life environment 34 and a professional life environment 36 which are partitioned by partition logic 32. A single user account 40 is all that is needed to access and utilize multiple social media environments. The single user account 40 is associated with a user name and password but other methods of log in and user 2 identification are possible. It is also possible that multiple user names and passwords are utilized for the user 2, if desired, for security reasons or the user desires to log onto only one environment of the social media platform 30 at any given time. Foundational to the present invention is that once the user 2 has entered the social media platform 30 the user 2 can easily navigate multiple environments within a single platform. A partition logic 32 separates various components of the social media platform 30 to provide the user 2 with two environments to navigate with similar experience, yet keep each environment effectively separated. Essentially, people need to present a personal life and a professional life to others and information disclosed in one life may not be desired to be shared with others in another life. The partitioning permits the social media platform 30 to combine all relevant data to the user's social life environments, both personal and professional, yet keep that data separate unless the user 2 desires to combine that data for searching, updating, contacting, collaborating and whatever else is desired. The users 2 data is easily accessed in each life environment and utilized in that environment and can be utilized between each environment. Such ease of flow of communication, familiarity of similar navigation and access to social media data with a single user account 40 is not possible with the user 2 having multiple separate limited social media accounts.

FIG. 4 of the present invention illustrates the addition of an enterprise life environment 38 contained in the social media platform 30 with an enterprise partitioning logic 44. The method and system described above for FIG. 3 expands functionality by further enabling the user 2 in the social media platform 30 to access and utilize the enterprise life environment 38 under the same user account 40. A secure network layer 42 can be architected in numerous ways, yet has in common that the enterprise life environment 38 is privately controlled by an enterprise system administrator and the user 2 is permitted to associate his user account 40 to access and utilize the enterprise life environment 38 with the approval of the enterprise system administrator. Now the user 2 can have in one application of the social media platform 30 a means to navigate all aspects of the user's life. System administrators of the enterprise life environment 38 may be presented options for the partitioning logic 44. For example the system administrator may allow or may not allow contacts, data, content and other secure information to be combined or transferred into the users 2 personal life environment 34 and professional life environment 36. Even with some information limited to be transferred the user 2 still has instant access with the same navigational experience to the enterprise life environment 38. It is conceivable the user 2 can be a permitted member into multiple enterprise life environments 38.

Many methods of network architecture and configuration for accessing the internet are applicable to the present invention. It is preferred, but in no way limited to, the social media platform 30 being hosted by a single social media platform provider that controls all aspects of the platform. The web based platform can utilize a single data center for hosting and also can utilize multiple locations globally for increased speed, yet fully seamless in operation. Likewise the same is true for data storage for the social media platform 30. The secure network layer 42 and its private enterprise life environment 38 may be integral with the servers for the personal life environment 34 and the professional life environment 36 or may be served from servers designated by the enterprise system administrator. That administrator may represent a business, government, hotel, school, non-profit, special interest group or any entity. The enterprise designated server(s) may provide various levels of interconnectivity and data exchange with the server(s) used for the personal life environment 34 and the professional life environment 36. It is preferred that the user can access the enterprise life environment 38 from the internet and through the secure network layer 42 but that environment may be locked down and only accessible through a private network. No matter the deployed network architecture and configuration the social media platform 30 provides the user 2 a single user account 40 and a shared navigational control and ease for the user 2 to navigate among the environments.

Users of the social media platform 30 may be offered an account and/or environment for free, at a fee, fee for additional features as well as any and all other forms of possible benefit and monetary transfer. One possible approach is the social media provider offers for free the personal life environment 34 and supports that by advertising revenue and then charges for adding the professional life environment 36. Or both environments are offered for free and supported by advertising revenue. The user may be given an option for a reduced fee or no fee if they accept advertising. The enterprise life environment 38 may be monetized in any manner including advertising. The enterprise system administrator may opt out of advertisements and be charged a fee for each user. The enterprise system administrator may be charged for each added user by account or by bulk number of users. It is also conceivable the enterprise life environment 38 is paid for by the user 2. Fees may be paid on any time basis and may include any type of auto renew program logic, payment methodology, user verification and notification processes.

A primary embodiment of the present invention illustrated in FIG. 5 is to provide the user 2 with the ability to express his interests, products, services, opinions, business and any other matter of communicative expression. The user 2 is able to create from template and even customize rich content sites integral and relevant to each environment and fully searchable based on user 2 selected visibility program logic to those in each environment, between environments and publicly by internet access. The user 2 accesses and manages the social media platform 30 by the single user account 40. The user 2 in each respective environment may possess, manage and create a personal life site 58, a professional life site 60, and an enterprise life site 62 all partitioned within the platform. The sites may be a portion of a page of visual layout and even multiple pages of visual layout. They may have numerous links to content and actions to accomplish tasks both inside of the social media platform 30 and outside. It is also conceived that the user 2 may include advertising within the user 2 sites with a monetary transaction from third parties where revenues are retained solely by the user 2, solely by the social platform provider, solely by the enterprise life environment system administrator's entity, and/or shared among any of them. Further the social media platform 30 may provide a robust search capability associating the user 2 sites to groupings of search results based on numerous criteria such as topic, title, interest, keywords, product, service, opinion, purchase habitats, picture recognition, location, demographics to name just a few. Search may also correspond and/or integrate with third party search engines. The visual layout of the sites may appear tightly integrated with the design of the social media platform 30 and/or appear as a standalone website with minor navigational controls connecting to the social media platform 30.

Further, an embodiment of the present invention as illustrated in FIG. 5 provides the user 2 robust and visually rich group sites to create and manage. Group sites are categorized as a personal life group site 52, a professional life group site 54, and an enterprise group site 56 and all partitioned within the social media platform 30. It is preferred the group sites are based on templates and custom designed to create a rich web presence for the user 2 groups. The group sites contain members from the community of users of the social media platform 30 and conceivably could include guests from outside the community. Group site members are presented in one or both of listing by name and listing by picture reference. Access to group member profiles are provided and based on the individual members profiles associated to the particular environment the group site resides and possibly profiles from other environments based on visibility settings. The group sites provide numerous data points and features include, but not limited to, search by location, by demographic, by interest, by most recent activity and discussion boards, chat and other one and two-way communications, shared files, collaboration programs, project collaboration, polls, privacy settings, subgroups, selective permission for members to join/removed from the group and subgroups, group passwords, association by user profiles and interest with others, visibility controls by a group system administrator and individuals, postings, meeting times, where to meet and how to meet, past, current and upcoming events, calendar, and calendar integration with individuals calendars. Further groups may have advertisers that support the group site and the advertising revenues may benefit the user, the group, the social media platform provider, a third party, and in any combination. The visual layout of the group sites may appear tightly integrated with the design of the social media platform 30 and/or appear as a standalone website with minor navigational controls connecting to the social media platform 30.

FIG. 5 further illustrates the embodiment of the present partitioned social media platform 30 providing online shopping. Uniquely the partitioned platform enables the user 2 to provide a personal shopping store 46 and a professional shopping store 48. The user 2 creates an online business presenting products and services related to the specific environment. A complete online payment systems and optionally an order fulfillment system is incorporated into the platform and managed by the user 2. The user 2 may supply the payment system and incorporate into the shopping store site and/or the social media provider may provide the payment system and even optionally the fulfillment system to the user 2. Products and services are searchable by any criteria within the platform including categorizing by one of a single environment and multiple of environments. Advertising can be readily integrated into the shopping stores including targeted offers and messages based on various user profile and transactional data. Likewise the shopping stores can be accessed by the general public for review of the products and services being offered. An enterprise feature site 50 can share similar shopping store program logic and even a payment system and a fulfillment order system. For example an enterprise entity of an enterprise life environment 38 may have a company store for products and services offered to the community members within the enterprise life environment 38. The enterprise life environment 38 may be private to a hotel and features site 50 provides services advertisement products offered to hotel guests and accessible in any combination of before, during and after their stay.

The social media platform 30 may also include numerous methods to assist users and entities administering the enterprise life environment 38 to promote the personal life site 58, the professional life site 60, the enterprise life site 62, the personal life group site 52, the professional life group site 54, the enterprise group site 56, the personal shopping store 46, the professional shopping store 48 and the enterprise feature site 50. Promotion may also consist of promoting the users in the community of users of the social media platform 30. Promotion assistance by the social media platform provider may include among numerous options, search engine optimization, targeted advertising, press releases, and marketing campaigns.

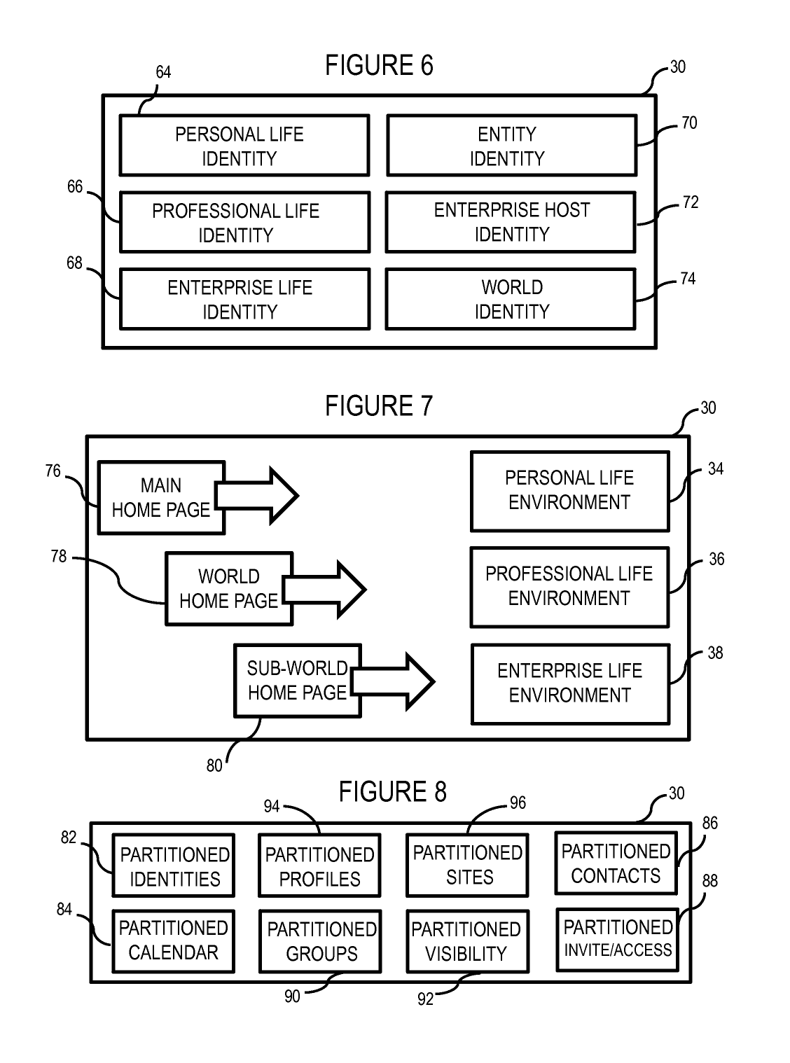

FIG. 6 presents in greater detail the various identities that utilize the social media platform 30. Each of the described above partitioned environments are utilized by several differing identities. For example the user 2 has a personal life identity 64 associated with the personal life environment 34, a professional life identity 66 which is associated with the professional life environment 36 and a enterprise life identity 68 associated with the enterprise life environment 38. The user 2 identity consists of parts or the whole of the user profile and any other related information identifying the user 2 with any related section of the social media platform 30. The identity not only serves to inform the user 2 of his presence in the social media platform 30 but also lets others know who the user 2 is, or least the environment associated with the user 2.

FIG. 6 also illustrates additional embodiments of the present invention where an identity is not specifically associated with the user 2 or any user. An entity identity 70 is any entity such as a business, a school, a government department, a non-profit and so on. It also may be a group or sub group with in the social media platform 30. The identity 70 is created and managed by a system administrator connected with the specific identity. A system administrator is one or several persons given access to the entity identity 70 for creating and management of the specific identity. The entity identity 70 may have its own searchable database and be further divided within the partitioned environments. Further the entity identity 70 may have its own section within the social media platform with all the features given to the user 2 including but not limited to sites, group site, sub group site and shopping sites as described for FIG. 5. It may also be desired to increase the offerings for the entity identity 70 with additional features such as more sites 58, 60 and 62, and more group sites 52,54 and 58 as well as a more enhanced shopping sites 46 and 48. On a larger scale an enterprise host identity 72 may be private to all but those invited into the enterprise life environment 38, or revealed to those only in one or more of the environments, or exposed to the public with even offers. The social media platform 30 may have a search function to locate all, a specific grouping, and a specific enterprise life environment 38 and its associated enterprise host identity 72.

FIG. 6 further creates a world identity 74 to create distinct sections within an environment built around a broad category of interest, entity product or service. For example a world can be “pro soccer” or “medical equipment” or “mutual funds” to name only a few. FIG. 7 illustrates that any of the environments 34, 36 and 38 can be populated with world identities 74. The social media platform 30 may have as its default page a main home page 76 where the general public first enters into the social media platform 30 online. A world home page 78 is a world identity 74 and may or may not be associated to a person, a group, a business, a school or any entity and also by interest, product and service. The world home page 78 may be the default home page and can be the designated home page by the user 2 making it the first point of entry into the social media platform. It may also be the first point of entry for the general public if they have been searching the specific entity, product type, service type or interest. Further a sub-world home page 80 can be one of many sub-world home pages under the world home page 78. As an example of the home world page 78 could be a hotel brand and the sub-world home page 80 could be one of many hotel properties under the brand. Of course there could also be other layers of sub-worlds under the sub-world home page 80. Also the user 2 may select on which page they want as their log on page and/or home page when entering the social media platform 30. Searching within the social media platform 30 can be categorized by worlds and sub-worlds as well as by any other criteria. Advertising on a world home page 78 and sub-world home page 80 can be a single advertiser or multiple advertiser and an advertiser can be a sponsor of a world or sub-world. Further a world identity 74 can offer an online shopping experience that is specific to any category including products, services and/or interests. Any home page in the social media platform 30 may also present marketing information encouraging visitors to create an account in the social media platform 30.

The social media platform 30 has program components that are partitioned between environments. Depending on the exact deployed configuration the present invention, as illustrated in FIG. 8, has as its preferred embodiment partitions for every aspect of the social media platform 30. FIG. 8 is not an exhaustive list but highlights primary program components that need to be configured for partitioned environments (personal, professional and enterprise). As described in FIG. 6 the identities are partitioned. A partitioned identities 82 logically separate identities to the corresponding environment. Still further a partitioned profiles 94 corresponds to its relevant environment. Likewise, a partitioned groups 90, a partitioned calendar 84, a partitioned sites 96, a partitioned contacts 86, a partitioned meeting invite/access process and logic 88 are all separated and correspond to their relevant environment. Further, partitioned visibility program logic 92 gives the user controls to any degree of visibility to others within an environment, between environments and to the general public. Further, data interaction in one environment may be utilized in another environment. For example, a user may seek to see contacts from one environment while in another environment. One of ordinary skill in the art may apply and customize the partitioning to suit a particular functional outcome.

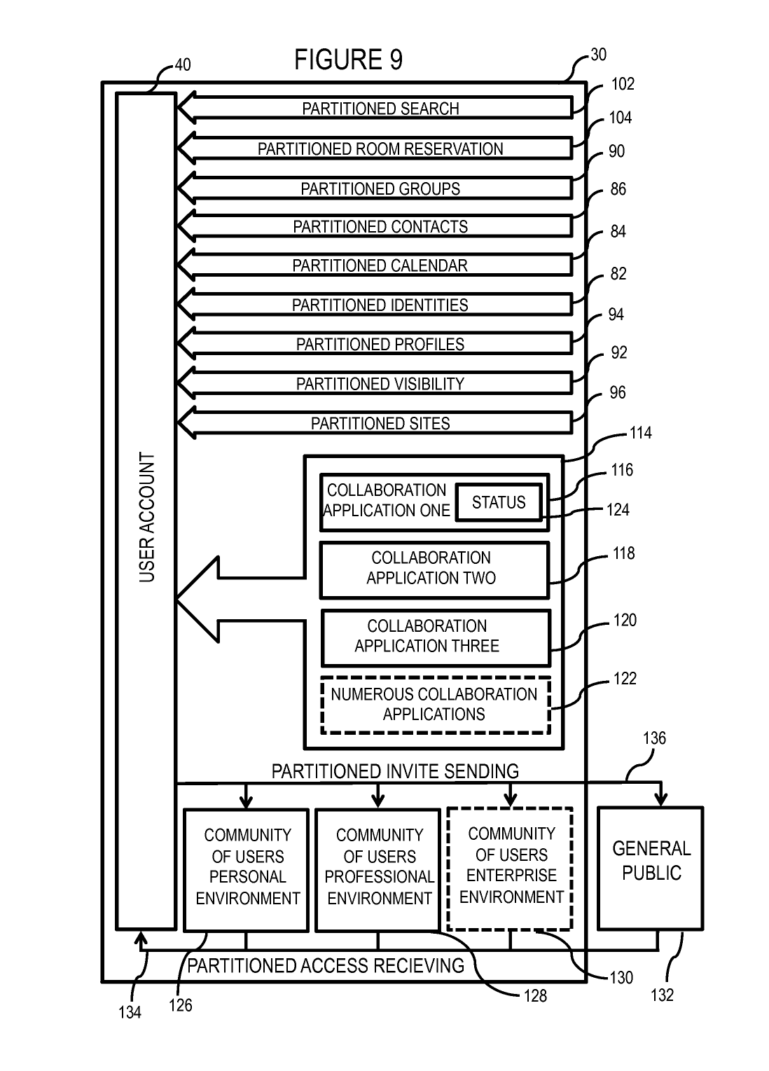

FIG. 9 illustrates the social media platform 30 with a partitioned search 102 program logic that enables the user to search every aspect of the social media platform. The partitioned search 102 program logic enables the user to search, for example, contacts, calendar, all identities with related information, groups, sub groups, comments, discussion boards, activity, chronological information, and physical location information. Further, social media platform 30 may search information in other applications and public information on the internet or in private databases. It is preferred, but not limited to, search being conducted within a specific environment for use in that particular environment. Yet, the user may also have need to search more than one environment of which may be added into the search program logic.

FIG. 9 illustrates further describes the partitioning method between environments. Specifically the social media platform 30 may include a partitioned room reservation 104 program logic that logically connects with the partitioned calendar 84 enabling users to determine “where to meet”. The user may elect when setting up a meeting to select a particular room in a particular building. The room may also be simply a place like a well-known coffee house group meeting location. The user may select one room or many rooms across many campuses. The rooms may all be recognized by the social media platform 30 as available or booked for a particular time slot as programmed and revealed in the partitioned calendar 84. When setting up the meeting the user may access data on the following and add the following contacts, identities, groups and people outside the social media platform 30. The user preferably selects, but not limited to, data from one environment with the intent to set up the meeting inside a particular environment.

While the partitioned room reservation 104 assist users with “where to meet” and engaged within a particular environment, FIG. 9 also illustrates a primary embodiment of the present invention assisting the user 2 with “how to meet”. The user 2 (not shown) accesses through user account 40 a grouping of collaboration applications 114 seen as a visual representation on a display (not shown), of which to utilize when setting up a meeting. The visual representation may be a simple listing of applications, iconic representation, app graphic buttons among other means for the user to see the grouping.

The user is presented information of potential options from the grouping of collaboration applications 114 of which to engage the meeting. The user may have an account with a particular application and thus notified of such in a status alert 116. The user may likewise be presented by the social media platform 30 options for new applications that the user may find useful. The social media platform 30 also recognizes when a meeting is set up among users and which applications the users share in common and may recommended other applications they may find useful to engage. That recommendation may be based on no criteria and solely be advertising driven. Further, the recommendation is based on any relevant data about the user and/or others invited to the meeting. Hence the grouping 114 of application one 116, application two 118, application three 120 and numerous collaboration applications 122 serves the user 2 and those he desires to meet in determining which application to engage.

Collaboration applications are any programs that enable users to hear, see, text, chat, written discussions, and share data and collaborate with data in real-time or not real-time. Certainly real-time communications is relevant to a live interactive meeting but meetings can also consist of delays between responses between users. Such programs are well known applications may include Skype, Lync, Face Time, Google Hangouts and a myriad of other collaboration applications. The sheer complexity for consumers to manage all these applications and “being in the dark” of not knowing how to communicate when creating a meeting with another person is fully resolved with the present invention. While the grouping of the collaboration applications 114 is novel for a social media platform with no partitioned environments it is especially applicable to each environment of the partitioned social media platform. For example, the personal life environment 34, the professional life environment 36 and the enterprise life environment 38 may have distinct offerings of the grouping of collaboration application 114 relevant to a person's personal and professional life and also what is approved by the organization of the enterprise life environment 38.

FIG. 9 further illustrates how the user 2 (not shown) with the user account 40 selects who is invited to a meeting by sending a request. The partitioned invite sending 136 program logic enables the user to select contacts from within one or more of a community of users personal environment 126, a community of users professional environment 128, a community of users enterprise environment 130 and the general public. The user 2 engages the partitioned invite sending 136 program logic and at least one of selects which applications form the grouping of collaboration applications to suggest to the invitees, the program suggests automatically which applications to use, and the program determines which are applications are used in common with the user 2 and the invitees. Next the applications in common are presented and the program suggests alternatives to one or both of the user 2 and the invitees. The invitees (that is one or more people) from the public or from any of the community of users respond by a partitioned access receiving 134 program logic. The logic permits the invitees to communicate to the user 2 which of the collaboration applications from the grouping of collaboration applications 114 is the desired method for collaborating. All well-known meeting set-up program logic is applicable to complete the process including auto response, notifications, calendar integration, email integration, text integration and the like with the user 2 application calendars and also with the invitees' calendars. Preferably the user 2 and the invitees use only the partitioned calendar 84 so that data exchange can be tightly integrated to support the selecting, suggesting and responding related to the grouping of collaboration applications 114. Further for those invited that do not share the social media platform 30 prompts to have them join the platform 30 will give them access to all the features of the platform. Such prompts can be embedded into the actual invites by one of numerous methods and joining techniques.

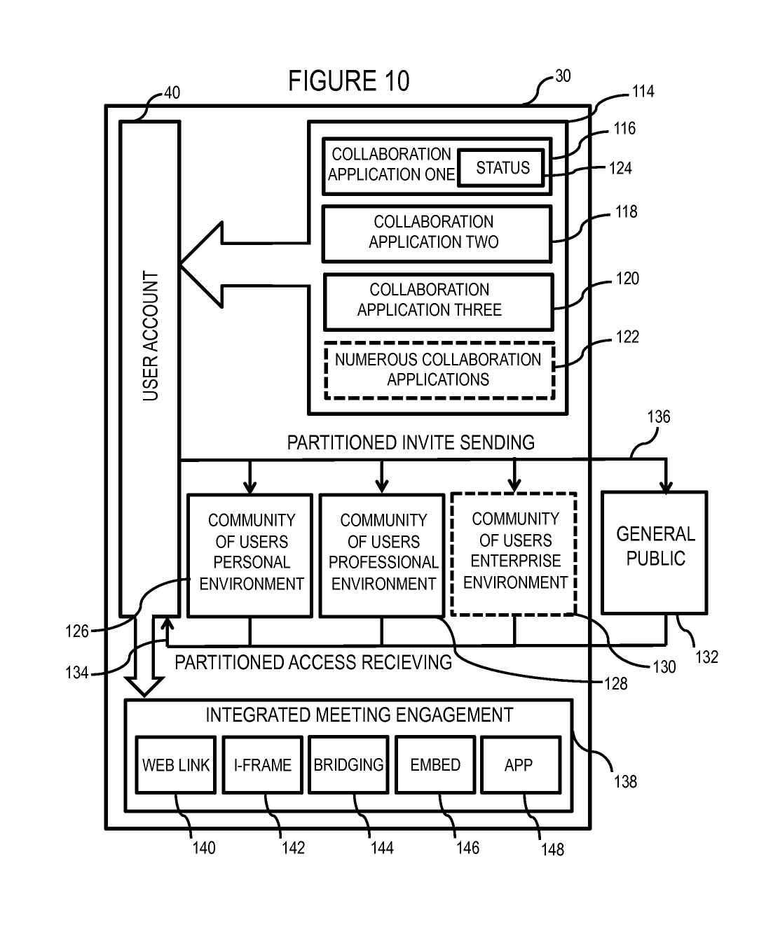

FIG. 10 illustrates the embodiment of FIG. 9 described above with the addition of a integrated meeting engagement 138 program logic. Beyond selecting, suggesting and responding is the streamlined methods to engaging a meeting using the applications from the grouping of collaboration applications 114. Options for engaging integral to the social media platform 30 is preferred to assist user 2 and all meeting attendants with the quickest and easiest way to collaborate. One preferred embodiment is to engage a particular collaboration application by a web linking 140 as a part of the partitioned invite sending 138 and partitioned access receiving 134 program logics. For example all communications between the user 2 and invitees can have a web link embedded to access the collaboration application in all communications and are also sent to all parties just prior to the meeting in a meeting notification. The web link 140 can be sent to the participants in an email, within the social media platform 30 and any other means. Another engagement method is to I-frame the collaboration application within the social media platform 30. I-framing is well known in the art and other methods of layering a web based application site into another site are all applicable to the present invention. I-framing should be understood narrowly and also broadly as the art of combining a site within a site. A primary advantage is that the social media platform 30 has an immediate navigational presence for the user 2 to access while simultaneously he and others utilize a particular collaboration application. Another possibility in engaging a meeting is a bridging 144 using a service or technology that accesses a particular collaboration application via a intermediary process. The bridging 144 is especially helpful when various protocols of collaboration applications do not communicate and the bridging enables them to actually interoperate. An example of this is common in the videoconferencing field. Ideally the bridging 114 is integrated inside of the social media platform and can be offered for free or at a fee. Another engaging method is an embedding 146 the collaboration application within in the social media platform 30. In this instance a particular collaboration application actually becomes an extension of the social media platform 30 by means of, for example, APIs and other custom software integrations. Still another engaging method is an app 148 designed for a particular personal computing device such as a phone or tablet. Conceivably options can be presented to the user 2 and the invitees of how they want to engage a particular collaboration application as it relates to a specific device. In conclusion the integrated meeting engagement 138 is applicable to the social media platform 30 with partitioned environments and is also applicable to social media platforms that do not have partitioned environments.

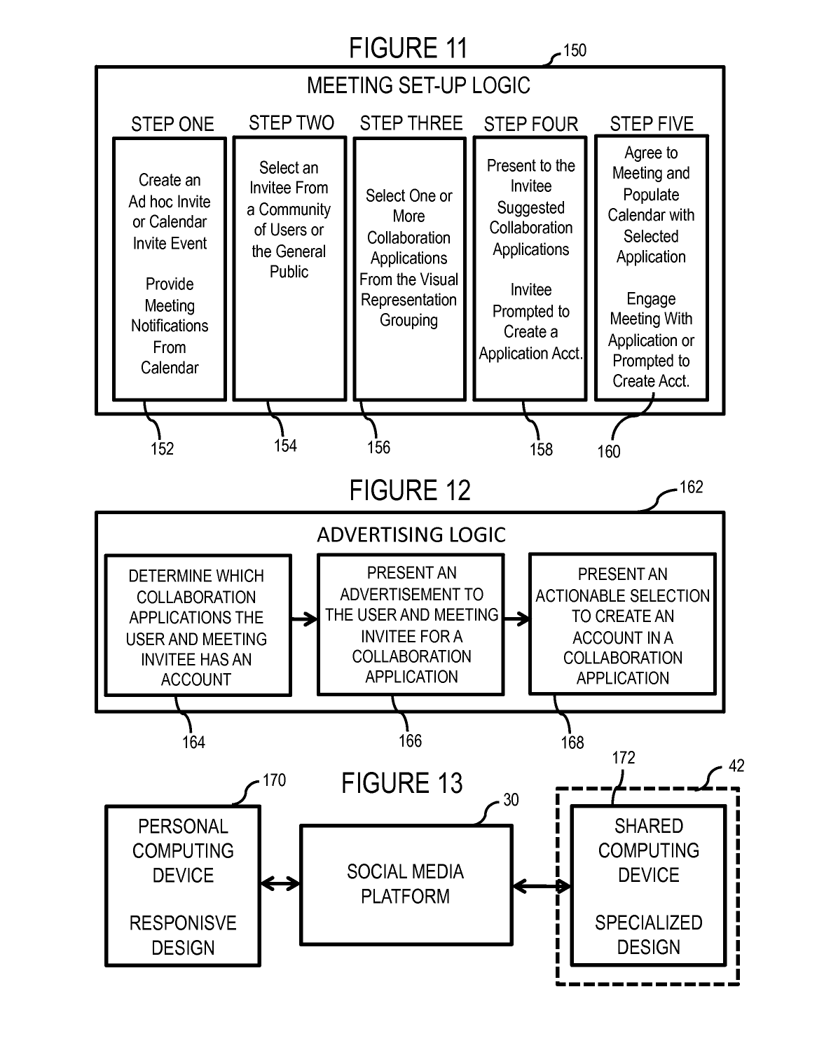

FIG. 11 presents a method of a meeting set-up logic 150 accessing a grouping of collaboration applications 114 within the social media platform 30. Step one 152 creates an ad hoc or calendar invite event and further provides meeting notifications from partitioned calendar 84. Step two 154 selects invitees from a community users from within the environments and the general public. Step three 156 selects a collaboration applications from the grouping of collaboration applications 114 and presented as a visual representation. Step four 158 presents the suggested collaboration for the meeting. If the invitee does not participate in the social media platform 30 they are prompted to do so. Likewise if the invitee does not share a suggested collaboration application they are prompted to do so. Step five 160 the user and invitees agree to a meeting and agree to the time and the collaboration application to be used for the meeting. Finally the meeting is engaged and a final prompt is presented for the user 2 and/or the invitees if they have not engaged the suggested application. In the case of an impromptu meeting the steps one-five may be applicable. Also program logic can determine how the user 2 and the invitees previously met and automatically present that particular collaboration application to engage.

FIG. 12 illustrates an advertising logic 162 integrated with the meeting set-up logic 150. An account determination 164 is needed to determine which applications the users and invitees have. This data can be self-entered by the user 2 into the social media platform 30 and/or provided by third party data. For example, a collaboration application vendor may provide user 2 information upon release by the user 2. By doing so the vendor ensures the user 2 is encouraged to use the vendor's application and also further promote the application among invitees. An advertisement presentation 166 presents to the user 2 and/or the invitees options for alternative applications and even upgrades for applications of which they already have accounts. An actionable selection 168 prompts the user 2 and/or the invitees to engage a new collaboration application or upgrade an collaboration applications they may already have. Still further collaboration application vendors may offer ancillary advertising to the user 2 a part from the meeting set-up logic 150 and offer trial offers and discounts all within the social media platform 30 and targeted in the applicable personal, professional and enterprise environments. Further the social media platform provider may have a personal data share and auto sign up program logic connected with the collaboration application vendors so the user 2 may create an account for the new application efficiently and quickly. To that end it would be advantages for the platform provider to provide user and password management software integrated into the social media platform 30 to aid integration and consolidation. Conceivably an advertisement may be eliminated if the user 2 purchases a particular service or upgrades the social media platform 30. The advertising logic may not be applicable for some enterprise life environments 38 where the entity that controls it may have preselected the particular collaboration applications. In that case notifications to user 2 and invitees serve as reminders of which collaboration applications are required for full participation in the enterprise life environment 38.

FIG. 13 illustrates the intended devices that are utilized to access the social media platform 30. A personal computing device 170 illustrates how users may use any type of device to access the platform. For example, but not limited to a mobile phone, a tablet, a notebook, a desktop computer, a TV, a head mounted display, and wrist mounted device. Depending on the display (not shown) of the personal computing device 170 the social media platform 30 is preferably a responsive design visual layout that is best suited for the type and size of the display. For example, a mobile phone may provide a modified experience as compared to experience on a desktop computer display. Further, a TV may provide content intended for viewing from farther away than when viewing the same content on a notebook. The present invention also embodies accessing the social media platform 30 by a shared computing device 172. Corporate meeting rooms, hotel rooms, public spaces, classrooms and many other potential cases a multitude of users may have access the social media platform 30 with a shared computing device 172. That device may display the social media platform 30 the same or modified from the experiences on the personal computing device 170. The shared computing device may also be utilized within the secure network layer 42 and have intended use by authorized persons in an enterprise. It may also be associated with only an approved environment such as a particular enterprise life environment 38. The shared computing device 172 could be any type of computing device including personal computers and specialty IPTV devices such as set-top boxes utilized for hotel TVs. Likewise, the shared computing device 172 could be built into a TV. The shared computing device 172 preferably has remote access and controlled by a system administrator so that updates and programs may be changed. The shared computing device 172 may have the grouping of collaboration applications 114 selected and loaded onto the particular shared computing device 172. A system administrator would also be able to control numerous devices so that all have the same functionality and the same accessible collaboration applications. Further users may be given all or levels of access at one or more of the shared computing devices 172. Access means could be by any means such as a password, voice recognition, pass key and any other means. The specific access means may also automatically identify the user 2 and auto log the user 2 into a specific enterprise life environment 38. It expressly understood that modifications connecting to shared computing devices to the present invention offers many variations and such variations in no way parts from the scope of this invention.

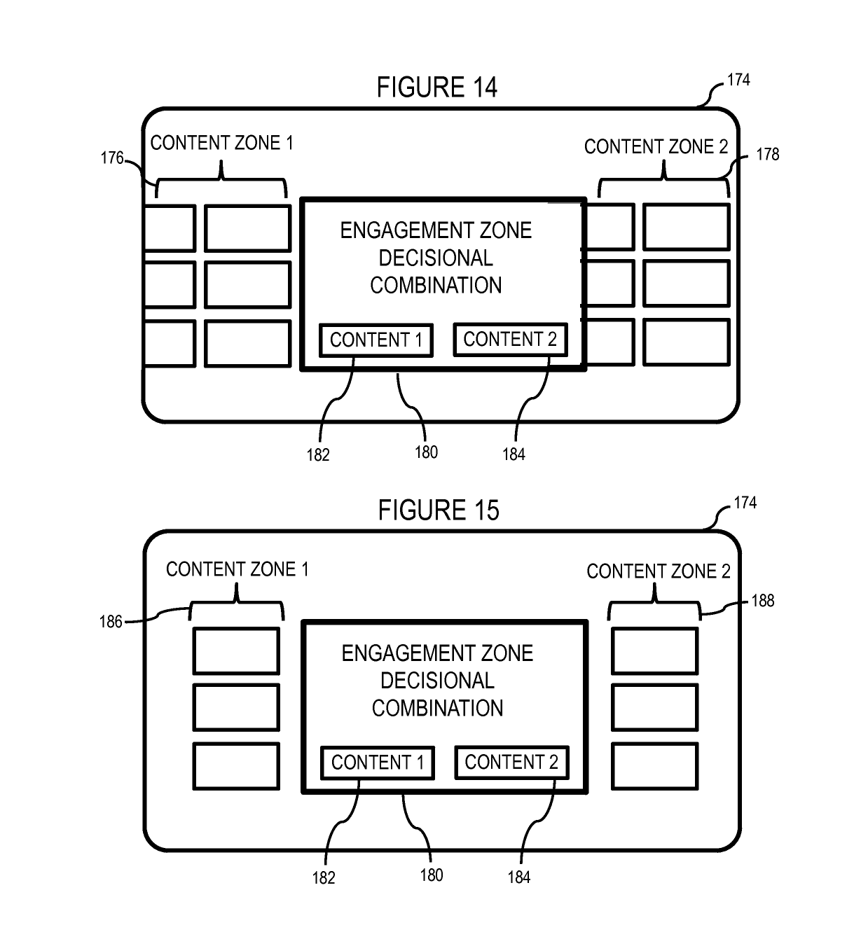

Those skilled in art will appreciate the vast creative options for visual layout design and navigational experience possibilities for the social media platform 30. FIG. 14 Illustrates an optional embodiment of the social media platform 30 navigational experience. A visual display 174 displays three distinct zones for presenting and processing information. A left horizontal content zone 176 and a right horizontal content zone 178 provides numerous elements of content for selection by the user. The elements of content slide left and right presenting numerous navigational elements. The elements of content can be groups, sub groups, contacts, worlds, environments, files, discussion forums, services, products and any other content category. Preferably the 2 two content zones 176 and 178 have relevance to each other. For example, the left horizontal contact zone 176 may present all the groups the user may be a member in a particular environment. Corresponding to that the right horizontal content zone 178 shows the contacts of a particular group selected from the left side when selected. The visual layout further provides a way to see the selected group and selected contacts in an engagement zone 180 that shows a content one 182 selected from the left zone and a content two 184 selected from the right zone. The engagement zone 180 provides for the user a visual representation of what content has been selected and placed in the engagement zone for further actions including decisional combination of selected content elements. That action can be, but in no way limited to, presenting the group and selected contacts in the zone to organize a meeting and prepare for sending a meeting invite.

The navigational layout of FIG. 14 is unique method for combing complex user driven selected content and prepare data for navigational action that depends on the information combined from two categories of content. Conceivably the engagement zone 180 could also contain more than two content selections from more than two categories. In that case each content zone 176 and 178 can have its own independent content selectors (not shown) to select a variety of content categories. It is also conceivable the content zones 176 and 178 can be hidden from view during portions of navigational experience and there by enlarging the engagement zone 180 and/or one of the content zone reaming on the visual display 174. The visual display 174 may be any type of display device with or without a built in computing processor. The illustration of the optional embodiment of present invention is seen in FIG. 15 and has the same functional intent as what has been described for FIG. 14. However, the horizontal content zones 176 and 178 have been replaced with a left vertical content zone 186 and a right vertical content zone 188. The vertical content zones enable the user to scroll the content elements up and down to select a content element. While this navigational method described for FIG. 14 and FIG. 15 is preferred, many other navigational options are possible for the social media platform 30.

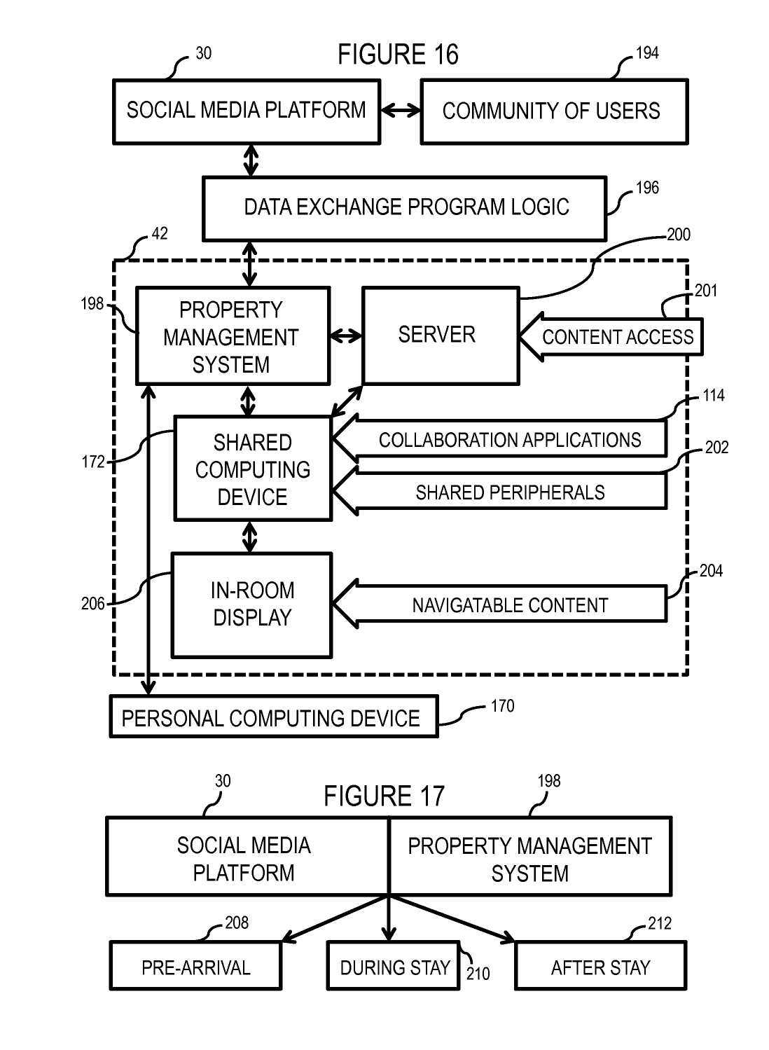

FIG. 16 Illustrates a primary embodiment to the present invention enabling the partitioned social media platform 30 to interconnect by means of a data exchange program logic 196 with a property management system 198. The property management system 198 may be used, but not limited to, in real estate, manufacturing, logistics, government or hospitality accommodation management. They are computerized systems that facilitate the management of properties, personal property, equipment, including maintenance, legalities and personnel all through a single piece of software. The following description and preferred embodiment specifically for hotel accommodations and has relevance to corporate enterprises. The secure network layer 42 is configured optionally in one of many variations and is illustrated to ensure that network security and the privacy of the enterprise network are taking into consideration. The property management system 198 as applied to hotels is often connected directly to the front desk, has remote assistance, numerous other integrated software applications and may be connected to a hotel chain software management system.

A community of users 194 (FIG. 16) is offered enhanced services during their stay at a hotel. A hotel should be understood as any kind of lodging facility for temporary stay of guest users. Specifically hotels are limited in presenting targeted services and products to guests since data on the guest is limited. The guest may be presented an option to join the social media platform 30 by the hotel, travel agent, and during online reservations among many other means to initiate joining and creating an account and user profile. Likewise, a guest may already have an account with the social media platform 30 and then chooses to release the information for access to the property management system 198. The information released may be the user's guest profile in the social media platform 30, as well as other information contained in the platform and any other source of information. Further, the guest may associate one or all of the guest user's personal life, professional and enterprise life with the property management system 196. The property management system 198 by means of the interconnected data exchange program logic 196 can present on an in-room hotel display 206 information and navigable content that has been confirmed by the social media platform 30 data including profile data. For example, a guest may show in his profile an interest for playing golf. The social media platform 30 informs the property management system of the interest and the shared computing device 172 processes the information and presents it on the in-room display 172 with, for example, tee times, golf related advertisement, golf related news, display other guests that may share the same interest, and even permit golf scheduling for a game among guests. Of course, visibility program logic applies and guests may prefer to select no visibility or a degree of visibility to other guests. Also enhanced communications can occur during conventions and seminars where guests can receive interactive feedback and conduct other community building activities while in the hotel room, all enabled by utilizing the social media platform 30 interconnected to the property management system 198. Any and all variations and interconnectivity of data will be readily apparent to one of ordinary skill in the art and as such does not depart from the scope of the present invention.

FIG. 16 also illustrates connecting the social media platform 30 with the property management system 198 for display upon the personal computing device 170. In this case the guest may view the content created by the data exchange program logic 196 on the personal computing device 170. That device may also be a portable device, such as a tablet, that is provided by the hotel to the guest. A server 200, connected to the property management system 198, is intended to serve content to the shared computing device 172. The server 200 receives content from any source such as satellite or the internet by a content access 201. That content may be broadcast TV, Internet access, hotel communications, IPTV and all other conceivable content. The shared computing device 172 also processes the grouping of collaboration applications 114 to collaborate with guests and non-guests. The shared computing device 172 may also have a shared peripherals 202 such as a printer, camera, microphone and USB hub, to name only a few options for use by the guest user. The in-room display 206 presents navigable content that has been organized by the combination of the social media platform 30 and the property management system 198 by means of the data exchange program logic 196. The social media platform 30 may be viewed on the in-room display 206 in a similar visual layout as is used on other devices or may have a visual layout unique to the hotel.

Another primary embodiment of the present invention is seen in FIG. 17. As described for FIG. 16 the social media platform 30 and the property management system 198 works in conjunction sharing information and processing information to present to the guest user unique navigational content and experiences specifically for the guest user. As seen in FIG. 17 those unique navigational content and experiences may also be presented to the guest user as a pre-arrival guest 208, during stay guest 210 and as an after stay guest 212. A guest may be provided information related to the social media platform 30 at the time of registering before arriving. The hotel can now target information directly to the user within the social media platform 30 and/or use data from the social media platform 30 to offer any type of customized combinations, services (such as fast check in), and products. Also the guest may be given information about other guests before arriving. Likewise, after the stay the hotel may be in contact with the guest to provide targeted advertising, discounts, services and products. The property management system 198 can be physically on the hotel property or, in whole or in part, in the cloud and may be connected to numerous other systems such as reservation and marketing software programs all of which can be interconnected with the social media platform 30. In the case of the pre-arrival guest 208 and the after stay guest 212 the social media platform data and connectivity may be handed off to another program server of which main function is not property management. In that case is would still be an extension of the property management system 198 as taught in this invention. Since the pre-arrival guest 208 and the after stay guest 212 does not readily have access to the shared computing device 172 the guest then utilize the personal computing device 172.

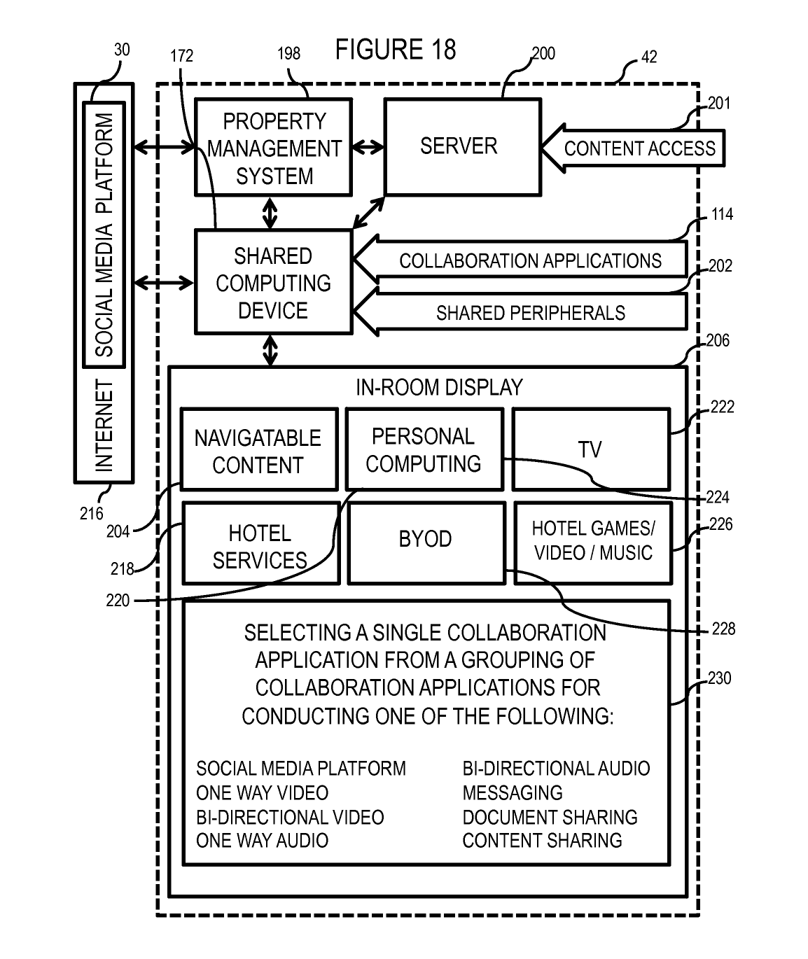

FIG. 18 illustrates a similar embodiment as described for FIGS. 16 and 17 except social media platform 30 and the property management system 198 are not interconnected. The description presented herein for the in-room display 206 is applicable to the embodiments illustrated and discussed for FIGS. 16 and 17 as well as any other embodiments of the present invention. The social media platform 30 is accessed by the shared computing device 172 as well as an internet 216. Specifically the shared computing device presents a grouping of collaboration applications so that the guest user may select one of many presented on the in-room display 206. The collaboration application selected provides at least one of a social media platform, one way video, bi-directional video, one way audio, bi-directional audio, messaging, document sharing and content sharing. Bi-directional video and audio enables videoconferencing and one way video and bi-directional audio allows guests to see and hear the hotel staff (and others) yet remains video private from the room out to the staff. Hotel services such as a live in-room video attendant utilizes the methods, systems and apparatuses of the present invention. A direct navigational link to an in-room video attendant, separate from the grouping of collaboration applications, is a preferred embodiment of the present invention. That direct link may as well use an application from the grouping of collaboration applications. The in-room display 206 also displays one or any combination of, and not limited to, a navigable content 204, a personal computing interface 220, a TV content 222, a hotel services 218, a hotel games/music/video 226 (live streamed and on demand), a BYOD (bring your own device) connectivity 228. The BYOD connectivity 228 can be hard wired by any means for video and audio as well as wireless.

The embodiments of FIG. 18 are discussed in detail as a hotel room solution, but by no means is limited to hotels. The in-room display 206 and the content produced by the shared computing device 172 are applicable to meetings rooms in corporate enterprises, classrooms, hospital rooms, to name only a few (except for that content that is specific to hotels). In such cases the property management system 198 is configured for, at minimum, basic enterprise network management and may be configured for remotely accessing and controlling the shared computing device 172. It is further to be understood that the present invention is applicable in homes as a purchased item and/or monthly rented service. The shared computing device 172 can replace cable, satellite, and phone TV services and when combined with the social media platform 30 the TV and on demand navigation can be integral in whole or in part with the social media platform 30. Further the user 2 may access the same combined navigable content on the personal computing device 170.

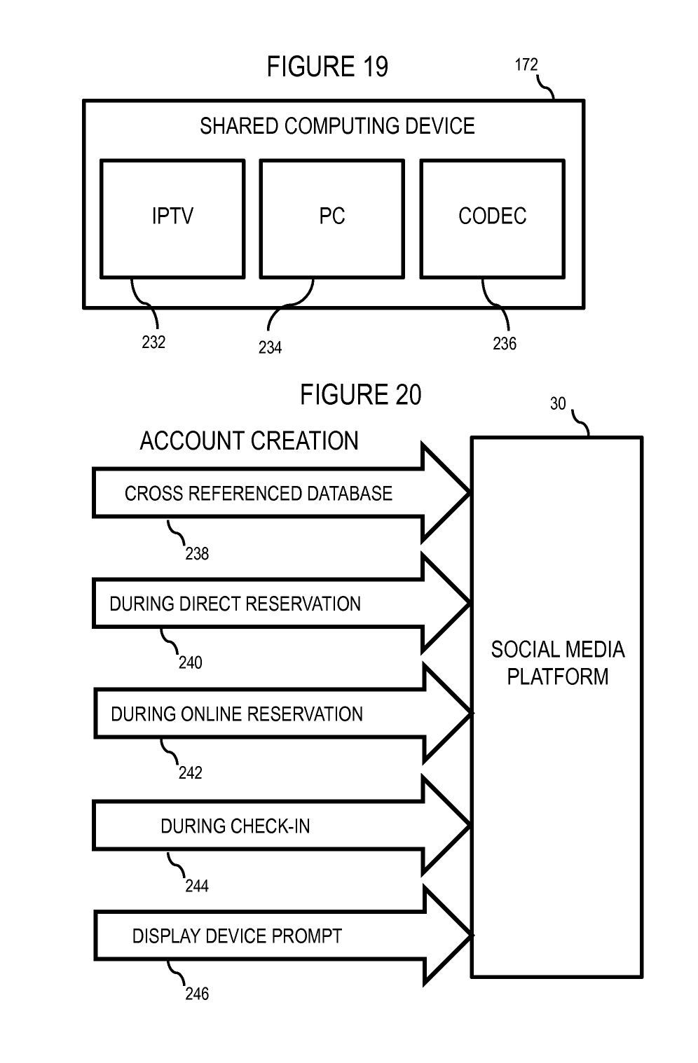

FIG. 19 illustrates the variations for the shared computing device 172. The shared computing device 172 may have one or more of a IPTV processor 232, a PC Processor 234 and a codec processor 236. The IPTV processor 232 may be very similar to existing IPTV boxes used in hotels rooms today. It is preferred the IPTV processor is powerful enough to process 4K video content, applications from the web and video games. The PC processor may run on a windows or Apple based operating system so the hotel guests (or meeting room participants in an enterprise) may be able to manipulate a operating system they have familiarity with and also permits specialized applications that require a specific operating system. Open PCs that are shared among users is highly problematic due the possibility the user downloads a virus, manipulates settings, downloads programs, and so on, all causing severe support issues. To resolve this a third party software, such as that provided by Faronics. Inc. will allow remote system operators to limit access, prevent harmful downloads, provide updates and even return the system to default settings after the user is done with the PC processor 234.

It may also be advantages to provide for the hotel room guest (or meeting room participant) access to a codec processor 236 designed to enable video and/or audio calls. Specialized software and also purpose built processors increase the quality of video calls. It is to be expressly understood that the shared computing device 172 should provide a high level of quality video and audio quality. While the shared computing device 172 is described herein as a single computing device, it is also to be understood and within the scope of this invention, that the shared computing device 172 is a system of computing devices. In that case the IPTV processor 232, the PC Processor 234 and the codec processor 236 may operate as a system selectable by the guest user for display on the in-room display 206. The in-room display 206 may also offer the ability to see the content from multiple processing sources. The IPTV processor 232 and the codec processor 236 are preferably controlled, updated and diagnosed remotely. It also may be advantages to provide the IPTV processor 232 in the in-room display 206 and the PC processor 234 and codec processor 236 outside the in-room display 206.

FIG. 20 illustrates methods for a potential user to join and become a user with the user account 40 in the social media platform 30. Specifically, a hotel guest engages a reservation and check by a variety means and the present invention seeks to utilize those means to also initiate the user joining the social media platform 30. First, the guest may be cross referenced in a database 238 of which information such as a simple name to more rich information can be used to create a user account 40. For example, the user may volunteer contact information or that contact information is sought out, independent of the user, from third parties to create a user account 40. It is also possible the user account 40 may be created for the guest and the guest user need only activate the account that already exists. Secondly, the user may create the user account 40 during a direct reservation 240 which is at a terminal, a travel agent or at another location to name only a few. The guest may also create the user account 40 during an online reservation 242. Those in the art will appreciate the many ways data from the online reservation 242 process can automatically populate name and basic profile information, as well as other relevant guest information for transfer to the social media platform 30. Third, a user account can be created from information gathered about the guest during a check in 244 at the hotel. At the hotel information can be entered into by the guest directly at a terminal or gleaned from information gathered during the check in process with and attendant. Lastly, the user account 40 can be created by the guest with a display device prompt 246. A cell phone, tablet, email, or even in-room display, to name a few, prompts the guests to create and/or activate the user account 40. With all the above options the guest can also be guided to create profile and assign relevant data in the partitioned environments of the present invention.

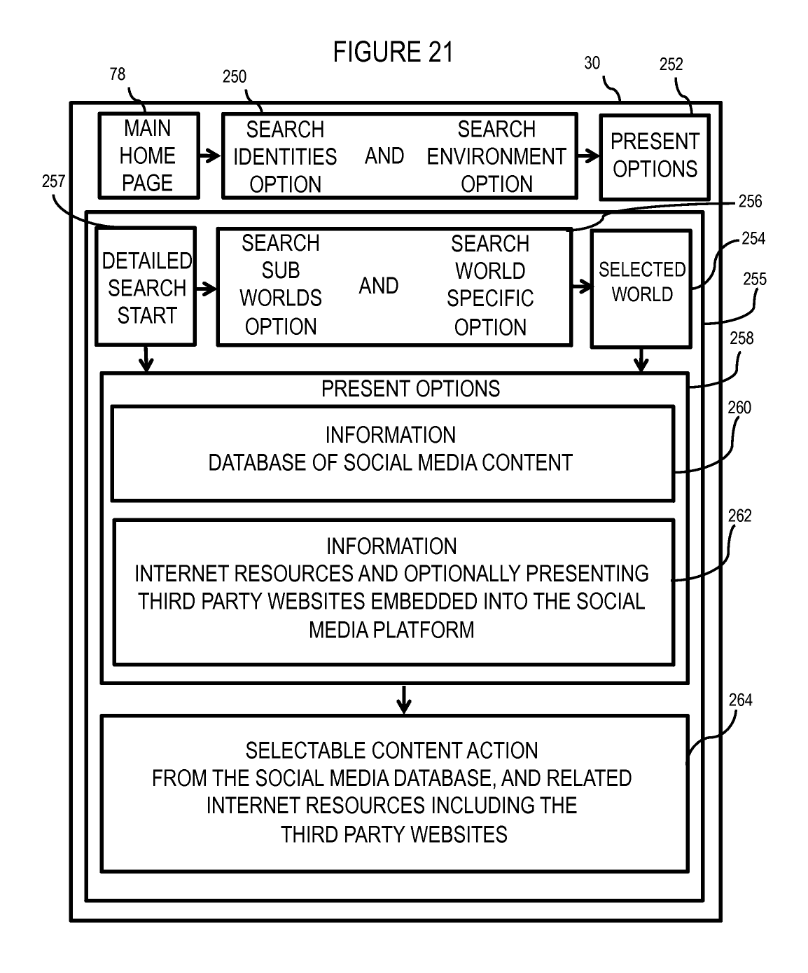

FIG. 21 illustrates search methodologies of the present invention. The user 2 accesses the main home page 78 or any page in the social media platform 30. The user 2 can search any identity as described in FIG. 6. An identity and environment search selector 250 initiates a basic search from one of, but not limited to, the personal life identity 64, the professional life identity 66, the enterprise life identity 70, the enterprise host identity 72, the world identity 74, the personal life environment 34, the professional life environment 36 and the enterprise life environment 38. Search criteria may be selected in any possible categorization and by any term and association of terms. Upon the initiation of the identity and environment search selector 250 initiates present options 252 which gives results based on a search engine program logic integral with the social media platform 30.

A detailed search start 257 enables the user to initiate a search in the social media platform 30 for any and all information contained within the platform, but also related information outside the social media platform 30. The user may first choose to select a particular environment as described above or search the worlds as explained in FIG. 7. A sub world and specific world search 256 is engaged by the user 2. Search words, key words, phrases and any criteria and category is entered such as “muscle car.” The search results provide options of a selected world 254 (which may be one of many results) presenting the next step in the search process which is an expanded search 258. Alternatively search may bypass the sub world and specific world search 256 and the user 2 may go straight to engaging the expanded search 258. Either from the selected world 254 or the detailed search start 257 the search for “muscle car” provides in the expanded search 258 muscle car information in a database of social media content 260. This information may be products, services, groups, contacts, any interest and any entity and any other information connected with “muscle cars”. The user may further filter the results to only shopping for “muscle cars.” The database 260 further presents shopping sites within the social media platform 30 selling “muscle cars”. Additionally the social media platform 30 can present results from the internet resources related to buying “muscle cars.” Further, an embodiment of the present invention is that third party websites 262 are embedded into visual display of the social media platform 30. This may be done with permission of the third parties and without. The embedding may be done by i-framing a portion or the entire third party website. Lastly, a selectable content action 264 enables the user to select the search information “muscle cars” and view data from the social media platform 30 and internet resources, including third party websites. While the example of “muscle car” has been presented of course the search criteria could be any subject, interest, product, service, organization, business, etc. It may also be advantages that people without a user account 40 can search and discover data contained within and try out the functionality of the social media platform 30. The search functionality of the present invention may very robust and serve as an internet search engine that scrubs the internet for information and displays it visually with the inherent data within the social media platform 30. The social media platform 30 may also be connected to another search engine with programmed integration.

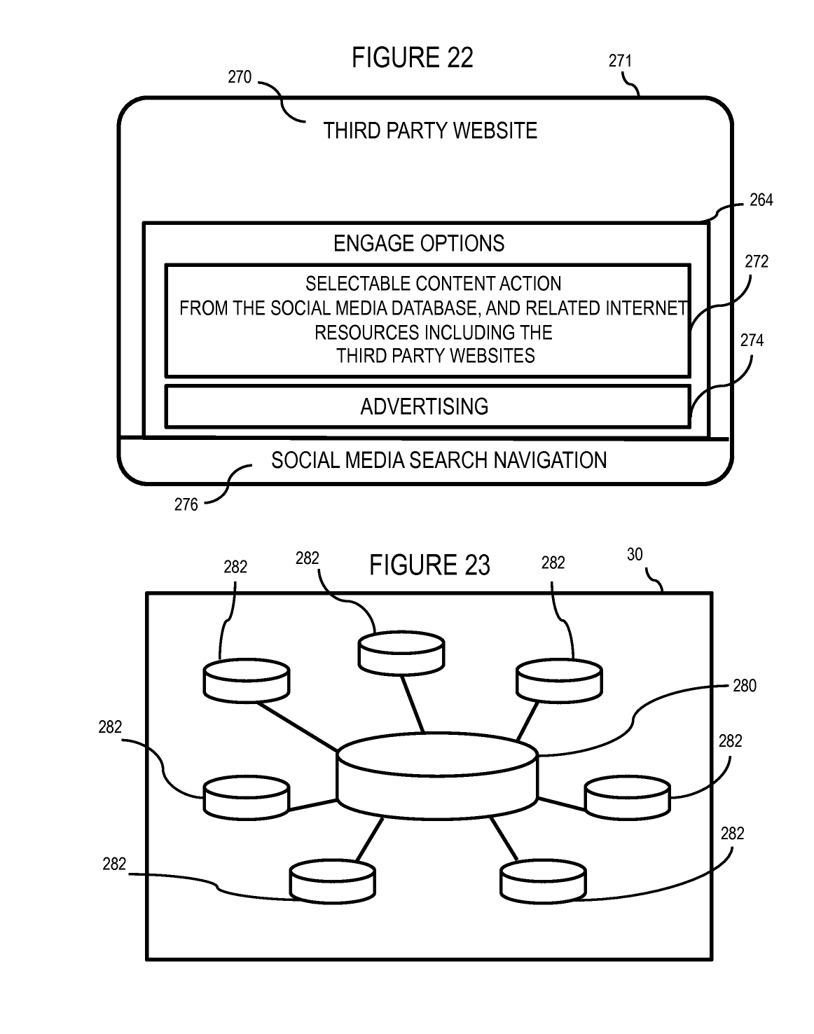

FIG. 22 illustrates a generic visual display 271 displaying the visual layout of the social media platform 30. Specifically the display 271 is showing a layout of the third party website as described in FIG. 21 and now displayed as a third party website 270. The third party website 270 is i-framed in the social media platform 30 controlled by a bottom navigational search bar 276. The search bar 276 is one of many options for the location of the presentation of the search navigation. An engage options visual layout 264 may be any type of visual layout. It may provide a targeted advertisement 274 which may be associated to the content of the third party website 270 or the general search parameters. For example, the advertisement 274 may be for a competitive “muscle car reseller” to the third party website 270 “muscle car reseller”. Data by which to determine the targeted advertisement may be from simple keywords to more complex analysis of numerous sets of data such as locality, purchase behavior, gender, age, profession, to name only a few. Further the targeted advertisement 274 may actually be associated to the third party website. The owner of the third party website 270 may contract with the social media platform 30 provider to place an advertisement while their website is presented on the generic visual display 270. Further the third party website 270 owner may contract with the platform provider to favor the third party website 270 in search results. Selectable content action 272 gives the user 2 the ability to engage numerous actions related to the third party website 270 and/or the social media database such as, but not limited to, request for more information and purchase a product or service. Preferably i-framing is designed in a way to create the impression that the social media platform 30 is minimal in its visual layout. Also as the user views an I framed site it is a preferred embodiment of the present invention that a quick and fast page turn action would allow the user to surf many third party website home pages seamlessly. To speed up the process the next third party website in the lineup could be preloading. As it relates to the hotel industry the present invention may create a massive world of global hotel properties and their websites. The information may be attained by web scraping, web searching, and using APIs for direct interconnectivity. The platform users will be able to search the actual websites of the various hotel properties in locality, among numerous other data sets, and be able to navigate from condensed search categories. Further room reservation websites, reservation programs and third party reservation software may be integrated into the social media platform 30. That includes amalgamating website reservation systems and helping the user 2 to navigate the various applications and select a specific applications. Likewise, social media platform 30 is seamlessly linked to a reservation service with an exchange of information related to the user 2 and the user selected hotels. Still further a hotels own reservation system may be directly linked to the social media platform 30 for immediate and direct bookings. The same as described above can also be applied to the social media platform 30 serving as a plane and car reservation system.

FIG. 23 illustrates the present invention in a manner of symbolic representation that can be utilized in word description and graphic design to assist users in navigating the social media platform 30. The sheer complexity of managing numerous collaboration applications, as well as worlds, groups, environments, contacts, social media, and more can be simply overwhelming. The present invention specifically incorporates word descriptions and visual representations, such as a virtual environment of an airport to help users navigate the social media platform 30. That environment visually can be both or one of the exterior or interior of buildings. The visual representation can be literal or styled with artistic variation. A main terminal 280 is the main terminal of a virtual airport and would be associated with the social media platform 30. It is the main entrance point and central location into a travel social media experience. Connected to the main terminal 280 are hubs 282 (secondary locations) of which each hub is associated with a collaboration application of which to launch a particular application. Further, common social media language can be modified to assist word descriptions in the context of the travel industry such as replacing “dashboard” with “flightboard”, “help” with “slipstream” and other words to build an associated mental and emotional impression. Hubs 282 may also be worlds as described in this invention and any other relevant category. Conceivably the symbolic representation of the airport could be multiple stories or alternate concourses assisting users from the main terminal navigating major categories with each being a hub 282 such as Google, Microsoft, Apple, and other collaboration applications and then become more specific. In other words, each hub 282 may have sub hubs serving as third locations (not shown) and so on. As gaming engines become more sophisticated, applications programs become more robust, and browsers become more feature rich it would be ideal to permit users to navigate a virtual airport as a means to navigate the social media platform 30. Such virtual world navigation may also be adapted to other symbolic representations such as office buildings and campuses for corporate enterprise social media experiences. Foundationally and in any of the use cases a central location and secondary locations are visually represented with association with objects in the physical world to assist the user in categorizing and navigating diverse sets of information. Also education institutions could also be displayed with symbolic representation and a virtual world. It is preferred that the user 2 may participate in organizing the virtual world around his chosen applications and may enjoy actually creating parts or the entire virtual world.

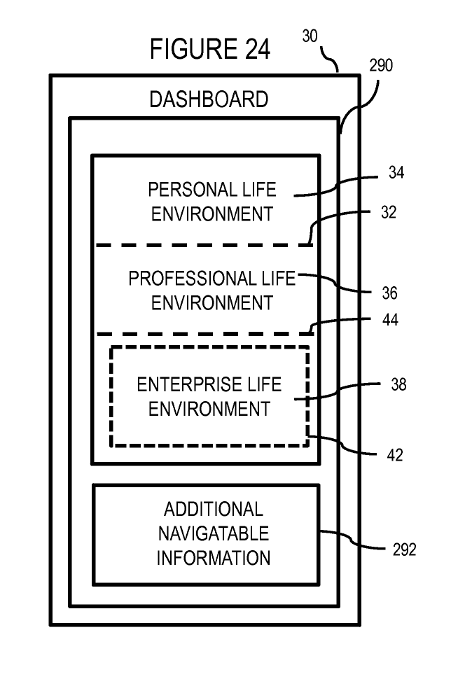

FIG. 24 illustrates a dashboard option of the present invention. A dashboard 290 presents to the user 2 on a visual display (not shown) at least 2 of the personal life environment 34, the professional life environment 36, and the enterprise life environment 38. The enterprise life environment may be optionally with the secure network layer 42 and is a private community of users, such as corporation or a hotel. So at minimum the user 2 is presented a method to navigate between environments by selecting an environment to enter. Of course the dashboard 290 can have an additional navigable information 292. That additional navigable information 292 can be any relevant aspect of the functionality of the social media platform 30 as described herein and also any additional functionality of common social networking well known in the art. The dashboard is also intended to provide alerts, news feeds, RSS feeds, feeds from other social media, notifications and snapshots of activity in each environment. Further the dashboard 290 may offer rich search capabilities and is designed to engage many of the navigable features of the social media platform 30. Also the design is preferably minimizable and expandable allowing the user to access it at will when using social media platform 30.

It is optionally preferred the present invention and the social media platform 30 is connected to a high-end network operations center (NOC) and high-end videoconferencing and telepresence are integrated into the platform. Both soft clients and appliance based videoconferencing could be controlled by the NOC. The advanced level of video service could also be provided for a fee. The NOC and/or a data center could also have multipoint control units or specialized routers enabling multipoint conferencing. A robust multipoint capability would help build online groups within the social media platform 30. Also videoconferencing can be embedded into numerous aspects of the present invention such as having a live attendant while online shopping or quick one touch call to an expert, friend, teacher, or business associate. New advances in browser based conferencing and other systems enable users to make video and audio calls without the need to download a software application. Such browser based collaboration applications may certainly be in the grouping of the collaboration applications 114. Further, the social media platform 30 could offer for sale components for videoconferencing and extensive tutorials on how to build your own videoconferencing system. Further, the social media platform 30 provider can offer for sale completed and custom videoconferencing systems for all kinds of consumer and professional deployments.

The above descriptions and related figure illustrations of the embodiments the present invention requires persons skilled in the art of software programming and application and web browser design. Such expertise is well known in the art, will enable programmers to add to the functionality of the present invention such as LDAP integration, auto log in and password management program, online school platforms, to name only a few. Such additions are always a necessity in complex software programs and in no way departs from the scope of the present invention. Also, a sufficient understanding of network architecture, hosting and security is also needed for a successful deployment of the present invention. It is conceivable a particular application, such videoconferencing application, may be integrated into the social media platform 30 and that integration requires a much more complex network architecture configuration and design. For example it may require the social media platform be served from various regions of the globe to increase speed and performance and these regional servers are connected to operate seamlessly. Certainly existing software engines commercially available may be used and modified. For example, a search engine, a advertising engine, and other software modules may be utilized. Still further the shared media device 172 may be a custom built piece of hardware or an off-the-shelf device. Further many of the inventive embodiments described herein are applicable to a social networking site with no partitioned environments. Also, though much of the present invention teaches a unique application to serve hotel guests within a partitioned social media platform 30, a non-partitioned social media platform may be used for many of the variations of the present invention. Finally, many of the inventions herein are applicable with and without social media combined and should be construed as being applied to corporate, government, heath care, education and many other enterprises for deployment.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

We claim:

1. A computer-implemented method for providing a multi-functional social media platform, comprising the steps of:
partitioning the social media platform into a professional life environment and a personal life environment wherein each environment has a community of users collaborating in each environment;
creating a user account associated with the user in a social media platform, the user account used to manage by the user a professional life identity associated with the professional life environment and personal life identity associated with the personal life environment; and
obtaining from the user a professional life specific user profile for display in the professional life environment and a personal life specific user profile for display in the personal life environment and partitioned in the social media platform.

2. The method of claim 1, further comprising the step of:
associating the user account with an enterprise life environment and managing an enterprise life identity and an enterprise life specific user profile for display in the enterprise life environment and partitioned in the social media platform.

3. The method of claim 2, further comprising the step of:
having the enterprise life environment reside in a secure private network and permitting the user account to manage the enterprise life identity and enterprise life specific user profile after a system administrator has granted access to the user.

4. The method of claim 1, further comprising the step of:
providing a visibility control for the user to select a level of the user identification information, such level ranging from fully private to fully revealed, and selecting the user profiles from among at least one of the community of users in either environment, both environments and in the general public.

5. The method of claim 1, further comprising the step of:
providing a meeting invite process for the user to create and send an invite from within one of the environments to at least one of other users in the communities of users and the general public.

6. The method of claim 1, further comprising the step of employing access control utilized by the user to determine which individuals from at least one of the communities of users and the general public are granted access to collaborate with the user in one of none, one or all of the environments and the general public.

7. The method of claim 1, further comprising the step of organizing by the user within each environment a grouping of individuals from the community of users.

8. The method of claim 1, further comprising the step of providing meeting Invite process for the user to create and send a meeting invite with specific time and date to one or more individuals to attend a meeting in one of the environments, the individuals invited from at least one of the community of users and in a general public;

9. The method of claim 1, further comprising the step of including a room reservation system for booking a room in one or more locations.

10. The method of claim 1, further comprising the step of employing a computing network access device configured with restricted functionality for accessing the social media platform, allowing a multitude of users to access the social media platform with the device and not permanently modify the device settings and programs.

11. The method of claim 1, further comprising the step of using advertising content presented by the social media platform discretely separated by the user's relevant association with the professional life identity and the personal life identity.

12. The method of claim 1, further comprising the step of shopping content presented by the social media platform discretely separated by the users relevant association with the professional life identity and the personal life identity.

13. The method of claim 1, further comprising the step of using user content sites for the user to visually present in the professional life environment a navigable professionally life related content and in the personal life environment a personal life navigable related content.

14. The method of claim 1, further comprising the step of using an entity user account for allowing an entity user to participate in the social media platform relevantly associated with at least one of the professional life environment and the personal life environment, the entity being at least one of a business, a school, a non-profit, a club, a religious community, a healthcare provider, a government and a special interest group.

15. The method of claim 1, further comprising the step of searching by subject at least one of keywords or phrases and presenting results of the subject search of related third party websites and visually displaying those websites within the social media platform.

16. The method of claim 1, further comprising the step of creating a world based on a subject of an interest, an entity, a product or a service, navigable within the social media platform, the world organizing an information set relevant to that world from at least one of a social media database, a database created from internet resources and a third party websites embedded in the social media platform.

17. The method of claim 16, further comprising the step of selecting a content action related to at least one of the social media database, the internet database, and the third party websites.

18. The method of claim 16, further comprising the step of using content action prompted by a targeted advertisement to the user.

19. The method of claim 1, further comprising the step of integrating into the social media platform a reservation system for at least one of meetings rooms, hotels rooms, air travel and automobiles.

20. The method of claim 1, further comprising the step of integrating into the social media platform a reservation system for at least one of hotels rooms, air travel and automobiles.

21. The method of claim 1, further comprising the step of creating a hotel world navigable within the social media platform, the world organizing an information set relevant to that world from at least one of a social media database, a database created by a world creator from internet resources and a third party website embedded in the social media platform.

22. The method of claim 21, further comprising the step of selecting a content action from at least one of the social media database, the world creator database, related to the third party website and in the context of the third party website.

23. The method of claim 21, further comprising: the content action was prompted by a targeted advertisement to the user.

24. A computer-implemented method for providing a social media platform integrating disconnected collaboration applications, comprising:
enabling collaboration with a social media platform with a user within a community of users, the user and community users identification information residing in a contact database in the social media platform;
meeting Invite process for the user to create and send a meeting invite with specific time and date to one or more individuals from at least one of the community of users and in the general public; and
displaying a grouping of collaboration applications accessible by the user in the social media platform, one or more of the collaboration applications from the visible representation selectable by the user and included in the meeting invite as a suggested method to collaborate in a meeting.

25. The method of claim 24, further comprising the step of engaging a selected collaboration application from within the social media platform by at least one of web linking, web I-framing, bridging, embedding, and custom app.

26. The method of claim 24, further comprising the step of using suggestion prompt for prompting a meeting invitee of the user to create a particular account of a specific collaboration application among the grouping of collaboration applications associated with the user.

27. The method of claim 24, further comprising the step of employing collaboration application status indication for presenting to the user the visual representation of the grouping of collaboration applications, a status indicator for the user to assess which specific applications among the grouping the user currently has an account and those specific applications the user does not have an account.

28. The method of claim 27, further comprising the step of presenting targeted advertising to the user for which an account for a specific collaboration application has at least one of not been created, lapsed in use, and needing upgrade.

29. The method of claim 24, further comprising the step of providing meeting engagement utilizing a specific collaboration application presented upon a calendar scheduled meeting notification to at least one of the user and a meeting invitee.

30. The method of claim 24, further comprising the step of including a room reservation system for booking a meeting room in one or more locations.

31. The method of claim 24, further comprising the step of having site origination served from at least one of a cloud server for public access and a private server for private organizational use.

32. The method of claim 24, further comprising the step of employing a computing network access device configured with restricted functionality for accessing the social media platform the user and allowing a multitude of users to access the social media platform with the device and not permanently modify the device settings and programs.

33. The method of claim 24, further comprising the step of employing advertising content presented by the social media platform for visual display of an advertisement of a specific collaboration application among the grouping of the collaboration applications, with advertising logic determining the specific collaboration application is unassociated with the user.

34. A computer-enabled method for providing a social media platform configured to enhance the user experience in a hotel, comprising:
enabling collaboration with a user within a community of users with a social media platform, the social media platform served from a cloud and accessible to the general public;
integrating the social media platform with a hotel property management system with a data exchange program logic;
recognizing when the user is registered in a hotel to provide an enhanced and personalized service in at least one of pre arrival, during the stay and post visit; and
presenting to the user a visual display interface with a navigable content related to the hotel to access by the user the enhanced and personalized service.

35. The method of claim 34, further comprising the step of applying the data exchange and program logic to enhancing and personalizing the hotel services in at least one of hotel reservations, access to hotel amenities, scheduling activities at the hotel, communicating with hotel staff, checking in and checking out processes, presenting updated hotel events and activities, and presenting regional events and activities.

36. The method of claim 34, further comprising the step of using the data exchange and program logic to enable hotel guest interaction by offering levels visibility of information contained in the social media platform related to a user's profiles and a user's list of interests.

37. The method of claim 34, further comprising the step of having the visual display interface and the navigable content displayed upon at least one personal computing device consisting of a personal PC, a notebook, a tablet, a phone, a remote control with screen, and a permanent in-room hotel computing device.

38. The method of claim 34, further comprising the step of enabling the program logic to produce the navigable content by utilizing at least one of a personal computing device and a permanent in-room hotel computing device.

39. The method of claim 38, further comprising the step of having the navigable content produced by the personal computing device modifiable on the parameter conditions of at least one of the user prior stay, during stay and after stay at the hotel.

40. The method of claim 39, further comprising the step of having the navigable content on the personal computing device accessible in the social media platform as a priority destination site enabling messaging from the hotel to the user.

41. The method of claim 40, further comprising the step of employing a graphical layout themed similarly to create a user experience continuity between the personal computing device and the in-room hotel computing device TV.

42. The method of claim 34, further comprising the step of enabling collaboration through the social media platform among the user registered at the hotel and with at least one of any users within the community of users, guests registered at the hotel, hotel staff and the general public by at least one of live one way video, live 2 way video, bi-directional audio, bi-directional chat, bi-directional document sharing and bi-directional live content sharing.

43. The method of claim 34, further comprising: federated site origination serving the social media platform from the cloud and connected with a hotel server operating the hotel property management system.

44. The method of claim 34, further comprising the step of enrolling a new user into the social media platform by at least one of a cross referenced database, a direct reservation, a online reservation, a check-in and a display device prompt.

45. A computer-enabled method for providing a hotel guest access to disconnected collaboration applications, comprising the steps of:
Providing a computer located permanently in a hotel room and accessible by the guest; the computer remotely commanded enabling remote updates and diagnostics to occur through a hotel data network, the computer securely configured to prevent the guest's private data to remain on the computer after check out;
accessing by the guest a collaboration application among a grouping of collaboration applications displayed on an in-room display.
sharing peripheral computer components among the grouping of collaboration applications, the components including, a camera and a microphone;
accessing by the guest a preferred collaboration application, among the grouping of applications, connected to the hotel data network and the internet to engage at least one of a social media platform, a one way video, a bi-directional video, a one way audio, a bi-directional audio, messaging, document sharing and content sharing; and
connecting the user with at least one of a guest registered at the hotel, at a another hotel, hotel staff, friends, family, business associates and the general public.

46. The method of claim 45, further comprising the step of utilizing a videoconferencing appliance that shares the camera with the grouping of collaboration applications.

47. The method of claim 45, further comprising: a property management system connected with the computer with a data exchange and a program logic applied to enhancing and personalizing the hotel services in at least one of hotel reservations, access to hotel amenities, scheduling activities at the hotel, communicating with hotel staff, checking in and checking out processes, presenting updated hotel events and activities, and presenting regional events and activities.

48. A computer-enabled method for providing an enterprise network user access to disconnected collaboration applications, comprising the steps of:
Locating a computer permanently in a shared room and accessible by the user; the computer remotely commanded enabling remote updates and diagnostics to occur through a enterprise data network, the computer securely configured to prevent the user's private data to remain on the computer after ending a session;
accessing by the user a preferred collaboration application among a grouping of collaboration applications displayed on a shared room display.
sharing peripheral computer components among the grouping of collaboration applications, the components including, a camera and a microphone;
accessing by the user a preferred collaboration application, among the grouping of applications, connected to the enterprise data network and the internet to engage at least one of a social media platform, a one way video, a bi-directional video, a one way audio, a bi-directional audio, messaging, document sharing and content sharing; and
connecting the user with at least one of a enterprise remote user in the enterprise data network and a public remote user outside the enterprise data network.

49. The method of claim 48, further comprising the step of providing a videoconferencing appliance that shares the camera with the grouping of collaboration applications.

50. The method of claim 48, further comprising: notifying by the user the enterprise remote user and the public remote user of the preferred collaboration application to engage a meeting.

51. The method of claim 50, further comprising the step of responding to the user by the enterprise remote user and the public remote user at least one of acceptance of the preferred collaboration application to engage the meeting and suggesting from the grouping of collaboration applications an alternative collaboration application.

52. The method of claim 48, further comprising: presenting the grouping of collaboration applications upon a personal computer and enabling the public remoter user and the enterprise remote user to at least one of select and engage the preferred collaboration application.

53. A computer-enabled method for providing a virtual environment social media platform, comprising the steps of:
providing a social media platform for users to interact;
creating a grouping of collaboration applications accessible within the platform, the grouping created by at least one of the social media platform provider and the user; and
navigating a virtual environment of an actual structure that has a central location and secondary locations, the central location associated with the social media platform and the secondary locations associated each with a collaboration application.

54. The method of claim 53, further comprising: the virtual environment is an airport with a main terminal representing the central location and a hubs each representing a collaboration application.
